(19) United States
(12) Patent Application Publication
(10) Pub. No.: US 2004/0170725 A1
(43) Pub. Date: Sep. 2, 2004

(54) Edible articles that include edible optical elements and methods for producing same

(76) Inventor: Eric Begleiter, Boston, MA (US)

Correspondence Address: EDWARDS & ANGELL, LLP, P.O. BOX 55874, BOSTON, MA, 02205, US

(21) Appl. No.: 10/483,312

(22) PCT Filed: Jul. 8, 2002
(86) PCT No.: PCT/US02/21467

Related U.S. Application Data
(60) Provisional application No. 60/304,536, filed on Jul. 9, 2001.

(51) Int. Cl. A23L 1/00

(52) U.S. Cl. 426/87

(57) ABSTRACT

The present invention provides edible articles (e.g., candies, confections, foods and medicines) that incorporate optical elements (e.g., holographic or lenticular gratings, and/or printed patterns) capable of producing visually interesting and unique optical images and/or effects, wherein such optical elements are safe to consume, and do not detract from the taste of the edible articles, and wherein the edible articles can be manufactured (to incorporate the optical elements) via a variety of differing techniques, thus providing the ability to produce unique and visually interesting edible articles.

### BACKGROUND OF THE INVENTION

1. Field of the Invention

The present invention relates generally to edible articles, and particularly to certain foods, candies, confections and medicines (e.g., cough drops, throat lozenges, pharmaceuticals) that incorporate high-resolution holographic, lenticular and/or printed patterns or gratings. The present invention also discloses methods by which such edible articles may be manufactured to include a wide variety of such patterns and/or gratings, which produce visually interesting images and/or effects.

2. Background of the Invention

To some, selecting candy, confections, foods and medicines for purchase involves reading labels, and comparing prices of competing brands—the actual appearance of these products is a secondary consideration. For many others, however, the appearance of such products is one of, if not the most important considerations when making their purchases. For example, children (especially young children) tend to choose foods, candies and confections based primarily on the appearance of such products, as do those who purchase or order such products (and medicines) for promotional and/or marketing purposes.

This presents a problem for companies, because the majority of foods, candies, confections, and medicines, as currently manufactured, have non-unique appearances as compared to competing offerings.

Companies and/or manufacturers have tended to react to this problem in one of several manners. Some have attempted to vary the appearance of their foods, candies, confections, and medicines through one or more shaping techniques, e.g. molding, extrusion. Still others, in addition to or in lieu of shape variation, have attempted to place their products in unique containers and/or packaging, in hopes of increased product marketability. However, these types of approaches are widely known, and are utilized by many competing companies and manufacturers, and, consequently, have not proven especially successful in enabling a unique product appearance.

In some cases, the desire to produce visually unique foods, candies, confections, and medicines has actually resulted in products that are dangerous to consume. For example, some companies have attempted to manufacture novel candies by pouring a candy mass onto an allegedly visually interesting, yet inedible object (e.g., a sticker), and/or by placing an inedible object on or within an inedible holder or atop an inedible shaped stick, over which is poured a candy mass. However, the presence of the inedible object(s) within the candy mass is often difficult to visually discern. This, in turn, makes it possible, perhaps even likely, that one could bite into and/or accidentally consume these inedible objects, and, in the same vein, detracts from the visual uniqueness of such products.

Thus, the same problem remains—namely, how to make foods, candies, confections and medicines that are visually interesting and unique enough to stand out from among the competing offerings of other companies, but with the added complication of ensuring that these products are safe to consume. These visual effects, to be commercially viable, must also have an acceptable cost and be compatible with existing equipment and processes.

U.S. Pat. No. 4,668,523 represents a significant step towards safely solving this problem in that it discloses technology that can provide food, candy, confection, and medicine manufacturers and sellers with an increased ability to distinguish their products from those of other companies and, in turn, to capture the interest (and, ideally, the market share) of individuals and entities (e.g., children and promotional event planners) to whom the visual appearance of such products is an extremely important consideration in making their purchases.

The '523 patent is directed to edible holographic elements and methods for conferring holographic images onto foodstuffs. But although the edibles produced in accordance with the '523 patent are visually interesting, safe to consume, and do not detract from the overall taste of foods, they are not entirely optimal. In particular, the '523 patent offers a limited number of techniques for producing holographic elements, principally, forming a film in a mold to impart a hologram-producing pattern, and then demolding it for use as the outer surface of a candy where the pattern is exposed to the air. Also, in accordance with the '523 patent, only a limited range of holographic elements may be produced in accordance with the techniques, principally a diffraction pattern on the surface of the article.

Therefore, a need remains for edible articles (e.g., candies, confections, foods and medicines) that incorporate optical elements (e.g., holographic or lenticular gratings, and/or printed patterns) capable of producing visually interesting and unique optical images and/or effects, wherein such optical elements are safe to consume, and do not detract from the taste of the edible articles, and wherein the edible articles can be manufactured (to incorporate the optical elements) via a variety of differing techniques, thus providing the ability to produce unique and visually interesting edible articles.

### SUMMARY OF THE INVENTION

This, and other needs are met by the present invention, which provides edible articles (and methods for making optical elements that can be used in such articles) that include one or more optical elements that, when viewed, produce visually interesting and unique optical images and/or effects.

In accordance with an exemplary aspect of the present invention, an edible article comprises an outer periphery (e.g., the external, outermost surface of the edible article), an inner area (i.e., the area defined within the outer periphery), at least a portion of which defines an active optical region; and at least one edible pattern in combination with the article, carried on an edible image retaining element and being capable of producing at least one image or effect. By way of non-limiting example, the outer periphery of the edible article can include a high resolution diffraction relief and the inner area of the inner article can be made of one or more carbohydrates, amino acid polymers, fats or combinations thereof. Also, the edible pattern can either be initially visible, or hidden from view until the at least a portion of the edible article has been consumed.

The edible article can be a diffraction pattern, a lenticular pattern, a printed pattern, or a combination of two or more of such patterns, each of which can be transferred via a casting (e.g., molding), embossing (e.g., heat stamping) or printing (e.g., ink jet printing) technique, or via exposure to a high energy source (e.g., a laser).

The edible article can be comprised of first and second edible image retaining elements (e.g., substrates) that are bonded together (e.g., via a heat sealing technique) to define both the outer periphery of the edible article and the inner area within the edible article, before or after which, optionally, the outer periphery of the edible article can be least partially coated with a hard-boiled candy, a candy mass, or a molten candy sealing ring.

A first exemplary method of producing such an edible article, includes the following steps:

a) introducing an edible film forming material into at least two holding areas (e.g., molds, belt mechanisms, etc), wherein at least one holding area is designed to allow for transfer of at least one pattern to the film forming material, and wherein the pattern is selected from the group consisting of a diffraction pattern, a lenticular pattern, a printed patterns, and combinations thereof;

b) allowing the film forming material to set in each holding area to form a substrate in each holding area;

c) removing the substrates from each holding area, each substrate having a first surface and a second surface, wherein the pattern has been transferred to one of the first and second surface of at least one of the substrates;

d) causing the first and second surfaces of the substrates to be connected (e.g., via heat sealing) such that an optical gap is defined between the first and second surfaces of each substrate to which the pattern has been transferred; and, optionally,

e) introducing the connected substrates into a candy mass.

A second exemplary method of producing an edible article, includes the following steps:

a) providing first and second substrates, each having first and second surfaces;

b) transferring a diffraction relief grating onto at least one of the first and second surfaces of at least one of the plurality of substrates;

c) causing the first substrate to be connected to the second substrate such that an optical gap is formed between the first and second substrates, and such that each surface of the each substrate that includes a diffraction relief grating is facing toward the other surface of the substrate; and, optionally,

d) bonding at least one of the first and second substrates to a layer of hard boiled candy.

A third exemplary method of producing such an edible article includes the following steps:

a) providing a high energy source (e.g., a phase mask or a beam-producing device such as a laser (e.g., a neodymium-yag laser with a frequency setting based on the energy absorption profile of the edible article); and

b) exposing an edible article to a directed energy emanating from the high energy source such that a portion of the edible article is ablated to form a high resolution relief grating or pattern on the edible article.

A fourth exemplary method for producing such an edible article includes the following steps:

a) introducing a film forming material into at least two holding areas, wherein at least one holding area is designed to allow for the transfer of at least one pattern to the film forming material, and wherein the pattern is selected from the group consisting of a diffraction pattern, a lenticular pattern, a printed patterns, and combinations thereof;

b) allowing the mixture to set in each holding area such that a substrate is formed in each holding area, each substrate having first and second surfaces;

c) coating at least one of the substrates in the holding areas with a layer of hard boiled candy;

d) removing at least first and second substrates from their respective holding areas, at least one of the first and second substrates having a pattern on one of their first and second surfaces;

e) causing the first and second substrates to be connected (e.g., by bonding candy onto at least one of the first and second substrates) such that one of the first and second surfaces of the each substrate is facing one of the first and second surfaces of the other substrate, and such that an optical gap or region is defined between the facing surfaces of the first and second substrates; and, optionally, the following two additional steps:

i) shaping the articles into interlocking shapes; and

ii) bonding the interlocking shapes together by a technique selected from the group consisting of heat flow, cold flow, and a combination thereof.

A fifth exemplary method for producing such an edible article includes the following steps:

a) introducing a first film forming material (e.g., a hard boiled confection) into a first holding area that includes a pattern (e.g., a relief grating) with which the film forming material is in communication;

b) introducing a second film forming material into a second holding area;

c) allowing the mixtures to set in the first and second holding areas such that a first substrate is formed (e.g., with a lenticular-type relief grating) in the first holding area, and a second substrate is formed in the second holding area, the first substrate having a first surface in communication with the first holding area, and a second surface, and the second substrate having a first surface in communication with the second holding area, and a second surface;

c) bonding the second surface of the first substrate and the second surface of the second substrate together with molten candy such that the second surface of the first substrate is separated from the second surface of the second substrate by a predetermined distance;

d) adjusting (e.g., via sizing rollers) the predetermined distance;

e) allowing the molten candy to substantially cool; and

f) removing the first and second holding areas.

In accordance with a related method, a printed pattern can be introduced onto the second surface of the second substrate (e.g., via an ink jet printer) prior to the first and second substrates being bonded together. Alternatively, both the first and second substrates can have printed patterns imprinted on their second surfaces, wherein the printed patterns can produce images and/or effects that are superimposed when the edible article is viewed in a predetermined manner (e.g., from end to end).

A sixth exemplary method for forming/producing an edible article, includes the following steps:

a) providing a mold (e.g., a blank mold);

b) introducing film forming solution onto the mold;

c) allowing the film forming solution to form a substrate having a first, bottom surface, and an exposed, top surface;

d) introducing (e.g., via a printer device, such as an ink jet printer) a printed pattern onto the exposed, top surface of the substrate;

e) placing the exposed, top surface of the substrate into communication with a surface of a quantity of molten candy;

f) allowing the substrate to become attached to the surface of the quantity of molten candy, such that the printed pattern is in contact with the surface of the molten candy; and

g) removing the mold (preferably after the molten candy has cooled), such that the substrate remains attached to the molten candy.

The present invention also is directed to a method for producing an optical pattern on an edible article via a laser, wherein the method includes the following steps:

a) providing an edible article (e.g., a candy); and

b) causing the laser to emit first and second beams of light that interfere to produce a desired interference pattern (e.g., an interference pattern comprised of light intensity maxima and minima) on a surface of the edible article, and wherein the interference pattern produces an optical pattern (e.g., a microrelief or an optical pattern comprised of a plurality of grooves produced by lines of minimum light intensity from the interference pattern, and a plurality of ridges produced by lines of maximum light intensity from the interference pattern) on the surface of the edible article.

A seventh exemplary method of producing such an edible article, includes the following steps:

a) providing a blank mold;

b) introducing film solution material onto the blank mold;

c) allowing the film forming solution to form a first substrate having a first, bottom surface, and an exposed, top surface;

d) producing an optical pattern (e.g., via a laser emitting first and second beams of light that interfere to produce a desired interference pattern on the exposed, top surface of the edible article) on the exposed, top surface of the first substrate;

e) combining the first substrate with at least one other substrate to form an edible article.

In accordance with this exemplary method, the interference pattern can be comprised of light intensity maxima and minima, and the optical pattern can be a microrelief or can be comprised of a plurality of grooves produced by lines of minimum light intensity from the interference pattern, and a plurality of ridges produced by lines of maximum light intensity from the interference pattern.

Other aspects of the present invention are described below, and or are depicted in the drawings.

### BRIEF DESCRIPTION OF THE DRAWINGS

For a fuller understanding of the nature and desired objects of the present invention, reference is made to the following detailed description taken in conjunction with the accompanying figures, wherein like reference characters denote corresponding parts throughout the views, and in which:

FIG. 1 is a side view of two substrates, each including an optical element;

FIG. 2 is a side elevational view of the substrates of FIG. 1

FIGS. 3a and 3b are top views of the substrates of FIGS. 1 and 2 prior to (see FIG. 3a) and after (see FIG. 3b) being sealed;

FIGS. 4a and 4b are views in side elevation and perspective, respectively, of a substrate within a mold prior to (see FIG. 4a) and after (see FIG. 4b) being heat stamped;

FIG. 5 is a schematic view of an alternative process whereby a substrate is ablated via a laser source;

FIG. 6 is a perspective view of an exemplary multi-layered edible article in accordance with the present invention;

FIG. 7 is a perspective view of the edible article of FIG. 6 having been coated with an enclosing layer of candy;

FIG. 8 is a perspective view of the edible article of FIG. 6 following crimping thereof;

FIG. 9a is a side view of a substrate with a layer of candy atop the substrate;

FIG. 9b is a side view of the substrate of FIG. 8a following the introduction of heat to the layer of candy, which has since been caused to expand;

FIG. 10 is a perspective view of yet another multi-layered edible article in accordance with the present invention;

FIGS. 11a and 11b are perspective views of interlocking partial edible articles prior to (see FIG. 11a) and after (see FIG. 11b) being interlocked;

FIG. 12 is a perspective view of a process for manufacturing an edible article through the use of spacing rollers;

FIG. 13 is a side view of an edible article while being manufactured in accordance with the process of FIG. 12;

FIG. 14 is a side view of an edible article following completion of the alternative embodiment of the manufacturing process of FIG. 12;

FIG. 15 is a side view of an alternate embodiment of the present invention;

FIG. 16 is a side view of another alternate embodiment of the present invention;

FIG. 17 is a perspective view of yet another alternate embodiment of the present invention; and

FIG. 18 is a schematic view of an apparatus that allows for continuous manufacturing of edible articles in accordance with the present invention.

### DETAILED DESCRIPTION OF THE INVENTION

The present invention provides edible articles that incorporate edible optical elements, as well as methods for producing such edible articles that incorporate such optical elements, which, when viewed, produce visually interesting and unique images and/or effects.

The terms “optical element” and “optical elements,” as used herein, include holographic, diffraction, lenticular, and printed patterns and/or gratings, wherein “lenticular” patterns and/or gratings specifically include, but are not necessarily limited to, any corrugations, grooves or lenses.

Also, as used herein, the terms “diffraction relief” and “holographic” (and variations thereof) are intended to include/encompass the production of high resolution optical information as on a CD, images and effects as in a hologram, as well as the reconstruction of such information, images and effects using one or more sources (e.g., laser light or white, incoherent light). These terms also are intended to include any patterns that are produced/created through holography, patterns produced with ruling engines, and those produced with/by other techniques for the production of optical gratings that can be subsequently transferred to a structure by a mold or created directly on or in the structure via direct radiant energy (e.g., via laser ablation).

The terms “edible article” and “edible articles,” as used herein, refer to foods, candies, confections, and medicines that may be safely consumed by people and/or animals, and that are transparent, semi-transparent, or opaque.

By way of non-limiting example, such edible articles may include hard candies and hard-boiled sweets, compressed starch or sugar products, entirely or partially chocolate-based candies, jelly beans, licorice, chewing or bubble gums, film base tops for pastries such as cakes or cupcakes, so-called “gummy” candies, mints, drum coated confections (e.g., hard shell chocolates), and medicines (e.g., cough drops, throat lozenges, and pharmaceuticals such as compressed powder tablets, coated tablets, hard shell capsules, and soft gel capsules).

These exemplary edible articles represent a small subset of the universe of edible articles for purposes of the present invention, wherein such edible articles include any foods, candies, confections and medicines that are comprised of one or more materials/ingredients that are capable of receiving and retaining optical elements, and that do not detract from the overall taste of an edible article.

Exemplary such materials/ingredients include: food grade sugars (e.g., glucose, fructose, sucrose, dextrose, maltose and mixtures thereof, amino-acids (e.g., gels of albumin, casein, fibrin, and collagen and gelatins, and, in particular Bloom 150 to 250 gelatins), lipids (e.g., oils, triglycerides, and fats), waxes (e.g., paraffin, carnuba, and beeswax), various polysaccharides (e.g., carbohydrates such as cellulose and starches, complex gels, modified cellulose, and hydrocolloids, particularly gums such as tree extracts, acacia, tragacanth, larch, and root extracts including quar and quince).

Exemplary cellulose and starch materials may include amylase, rice, corn, potato, tapioca, hydrolyzed cereal solids, starch dextrose equivalent (D.E.) 0 to 5, dextrins, maltodextrins DE 5-30, standard dextrins 30-60 and high dextrins (conversion glucose DE 60-90), and exemplary complex gels may include pectin, seaweed, agar, carrageenin, algin, lack in 5 and 10 pound weights, and pregelatinized starch. Suitable modified complex gels, which are presently preferred, include hydroxypropylcellulose (HPC) and hydroxypropylmethycellulose (HPMC).

As noted above, optical elements suitable for the present invention include, but are not limited to, holographic, diffraction, lenticular, or printed patterns or gratings. Preferably, but not necessarily, patterns and gratings in accordance with the present invention are “high-resolution”. The term high resolution is used in two senses. When referring to a regular pattern of corrugations, grooves, or patterns acting as diffraction gratings, this means a structure of at least 400 lines per mm, and preferably about 1,000 to 7,000 lines per mm. When used with arrays (lenticulars) and printed images formed by ink on a surface, typically applied in a pure array of dots, “high resolution” means greater than 200 dots per inch (dpi).

Exemplary diffraction or holographic relief gratings are micro-gratings capable of diffracting visible light using a structure with the high resolution structures described above. Each grating also has a phase displacement in the range of about 0.5 micron to 1.0 micron, and a groove or corrugation depth in the range of about 0.5 micron to 1.0 micron. The dimensions of the diffraction relief grating should be proportional to the wavelength of the light with which the grating is to interact, and the angle to which it is to be diffracted. The information recorded and conveyed by the diffraction relief can be, for example, color, depth, image(s), optical data, and/or one or more kinetic effect(s).

Exemplary lenticular gratings in accordance with the present invention include vertical, horizontal and/or “in a grid array” lens structures molded or otherwise formed in or of suitable light-transmitting material. These lenticular gratings comprise in the range of about 20 lenses/inch to 100 lenses/inch, and up to and above 1000 lines/inch, and have a focal length in the range of about 20 microns to 200 microns. Surface structure fresnel lenses (as described below with reference to FIG. 16) can also be utilized, e.g., to help columnate light in order to reduce the effect of curvature on holographic reconstruction.

In some embodiments of the present invention, the optical elements are embedded/enclosed within an edible article such that the optical elements are protected/shielded from the atmosphere and its effects (e.g., excess moisture and/or heat), yet also such that they remain optically active—that is, such that they can produce their desired visual effects and/or images. By virtue of being protected from the atmosphere as such, the optical elements can have an extended visible life prior to and, depending on placement within the edible article, during consumption of the edible articles within which they are incorporated.

In other embodiments, the optical elements not embedded as such. For example, the optical elements may be produced/defined directly on an outer surface of the edible article. Although, in such embodiments, the optical elements are not necessarily shielded from the environment, they generally can be produced more quickly than optical elements embedded or enclosed within an edible article, and/or can produce comparatively more complex (and, thus, unique and interesting) visual images and effects.

In all embodiments wherein an edible article includes more than one optical element, an optical gap is provided between each of the optical elements. The optical gap is an area within the edible article that physically separates each optical element from the other(s). The optical gap can be an air gap, or can be comprised of a portion of the edible article itself.

The presence of one or more of these optical gaps within an edible article creates a boundary where transmitted light can refract and/or is diffracted through or off the optical elements, thus creating (or, in the case of holographic optical elements/gratings, facilitating) the diffraction of light and a related interference of lights from different frequencies and/or (in the case of lenticular gratings) the focusing of lenticular image(s) and/or effect(s). The optical gap should be wide enough (measured normal to the optical element separated by the gap in conjunction with a given differing index of refraction between the boundary layer and the optical elements) to produce the desired focusing, and, in turn, to enable the optical elements to interact in order to produce the optical phenomena of interference through diffraction and/or refraction of light.

Generally, the thickness of the optical gap should be greater than about 0.5 micron, and preferably in the range of about 2.0 microns to 200 microns. Optical gaps above 200 microns also are possible in accordance with the present invention, e.g., between two printed patterns.

It is understood that in embodiments wherein two optical gratings are in direct communication with (i.e., adjacent to and, at points, in contact with) each other, the gratings generally will not fit together exactly, and, consequently, an optical gap of at least 0.5 micron will be created/defined between the gratings.

A variety of methods are disclosed herein for producing edible articles that incorporate optical elements in accordance with the present invention, thus providing extremely valuable flexibility with respect to the cost and duration of the manufacturing process, as well as allowing for specific selection and placement of the optical elements, and, in turn, for the creation of edible articles with visually interesting and unique appearances.

For example, by selecting certain optical patterns and gratings, and controlling their placement within an edible article, the patterns and gratings may be viewed in combination to produce visually exciting images and/or effects that can be static or moving, and either two- or three-dimensional. Exemplary such images and effects include, but are not limited to, movies, scenes, logos, dissolve illusions and morphs, as well as conventional images and effects produced by holographic and lenticular gratings, and/or by printed patterns. “Movies' can be created, for example, by an image that changes as the viewing angle is modified that is, by rotating an edible article while observing it, a series of images can be seen, and if properly considered, can simulate a moving picture.

In accordance with an exemplary embodiment of the present invention, one or more relief-type molds (i.e., holding areas) are utilized to produce an edible article with incorporated optical elements. Each relief-type mold includes one or more diffractive, holographic or lenticular relief patterns or gratings on the surface of the mold. Exemplary such relief-type molds include, but are not limited to, those described in U.S. Pat. No. 4,668,523, as well as those described and depicted in published Patent Cooperation Treaty Application No. WO 01/10464, which was filed on Aug. 3, 2000 and published on Feb. 15, 2001, the disclosures of which are incorporated by reference herein.

A liquified solution of edible film-forming material is poured or otherwise introduced (e.g., roller coated, spun, dipped, sprayed or pressed) into the relief molds such that the solution is in contact with at least a portion (preferably all or substantially all) of the relief grating defined on the mold. Exemplary film forming materials include those ingredients/materials listed above, and, in particular HPC, HPMC, and complex starches and gels. The film forming solution is then dried (e.g., dehydrated), or is allowed to set (e.g., allowed to coagulate, evaporate, or cool) by remaining in contact with the relief mold for a predetermined time.

Once the solution is determined to be suitably dried or set, it is demolded (i.e., removed/separated from the mold) as is generally known in the art to produce a substrate. Preferably, the specific mold that is used is selected to produce a substrate with a desired size and shape—that is, a substrate that is not required to be cut once it is demolded. However, it is understood that many suitable devices (e.g., lasers, heated or non-heated cutting rollers) are known in the art for cutting substrates, should such action be required.

During the drying/setting process, the substrate will have received (e.g., been cast with) the relief pattern of the mold. Thus, when the substrate emerges from the mold, a diffraction, holographic or lenticular relief pattern or grating will have been transferred to the surface/side of the substrate that had been in contact with the pattern or grating defined in the relief mold. For a lenticular pattern, for example, a series of spherical depressions in the mold will produce a like series of concave protrusions on the substrate that act as a series of conveyor lenses.

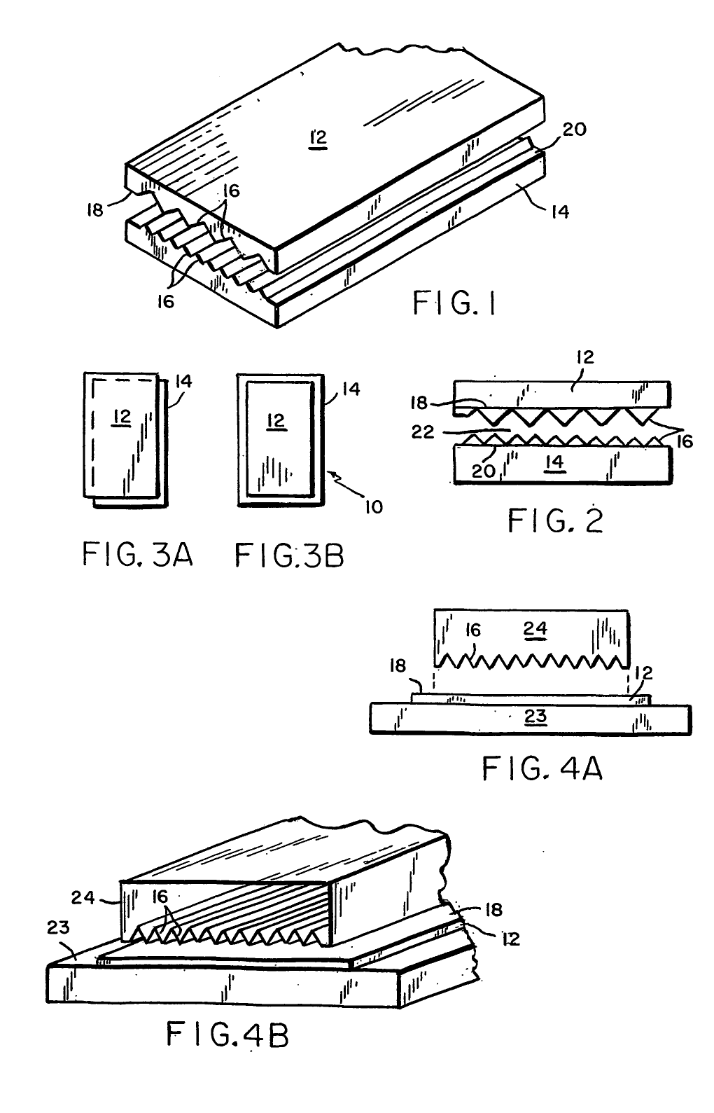

FIGS. 1 and 2 depict exemplary first and second substrates 12, 14, each of which includes a holographic, diffraction or lenticular pattern or grating 16 on one of its sides 18 (for substrate 12), 20 (for substrate 14).

The shape and dimensions of the molds used in connection with the present invention will depend on many factors, including, but not limited to, spatial constraints, the type of edible articles being produced, etc. The present invention is applicable, however, to embodiments in which anywhere from one mold to a multiplicity of molds are employed simultaneously or over a staggered time frame to produce one or more edible articles 10.

The molds may be either metal-, rubber-, plastic-, or wax-based, but, preferably, are made of a material that facilitates removal of the dried substrate 12, 14 from the mold without the former adhering to (i.e., sticking to) the latter. Exemplary plastic-based molds include those made of silicone, polytetrafluoroethylene or polyethylene terephthalate, and an exemplary metal-based mold is made of a nickel-based material.

Enough film forming solution/material should be introduced into the relief mold to completely and evenly cover the relief grating defined thereupon. The dimensions of the mold should allow for the substrate 12, 14 that emerges from the mold to have a thickness in the range of about 5 microns to 50 microns, and up to or exceeding 100 microns.

As shown in FIGS. 1-3b, an edible article 10 may be formed by sealing together a plurality of substrates 12, 14, each of which has emerged from a relief mold with one or more holographic, diffraction and/or lenticular relief gratings 16 on one side 18, 20 thereof.

To form the edible article via a sealing technique, the substrates 12, 14 are oriented such that their sides 18, 20 on which the relief gratings 16 are defined are facing each other as shown in FIGS. 1 and 2, and such that an optical gap 22 exists between the optical elements 16 following the sealing process.

Once the substrates 12, 14 are properly oriented as such, they are aligned (see FIG. 3a) and then are sealed or bonded together (see FIG. 3b) via a technique (e.g., heat sealing or heat bonding) generally known in the art to form a co-laminate, edible article 10 that includes optical elements 16 separated by an optical gap (not shown). Preferably, but not necessarily, the substrates are sealed around their entire periphery. Exemplary heat sealing temperatures are about 200° F. to 300° F. for substrates 12, 14 having thicknesses within the above-described ranges. The sealing can also occur at points interior to the co-laminate structure 10, e.g. as a series of line seals across the article (see FIG. 3b).

In an alternative embodiment of the present invention, the substrates 12, 14 are sealed through targeted application of one or more edible bonding materials, such as an edible glue, onto predetermined areas (e.g., the edges) of one or both substrates. A currently preferred edible glue is a vegetable gum

If the substrates 12, 14 are required to be cut following demolding, the cutting and sealing steps may be simultaneously effected through the use of one integrated device, e.g., a heat sealing cutting roller (not shown).

Once the substrates 12, 14 are sealed, they will have formed an edible article 10 that, due to the presence of the optical gap 22 and the optical elements 16, will produce optical images or effects when viewed. Also, because the substrates 12, 14 are sealed together, the optical elements 16 are protected from atmospheric exposure, thus reducing the likelihood that the optical elements will prematurely degrade (e.g., crack, wrinkle, fade and/or crystallize) for various reasons, e.g., due to exposure to excess moisture (i.e., above about 50% relative humidity) and/or excessive heat (i.e., above about 90° F.).

When viewed, the edible article 10 produced in accordance with FIGS. 1-3b will depict holographic and/or lenticular images and/or effects. For example, if each substrate 12, 14 included holographic gratings as its optical elements 16, these gratings, when viewed within the edible article 10, could produce a combined image or effect (e.g., a sparkle).

This edible article 10 can be consumed, or, preferably, a plurality of these edible articles 10 can be shipped to other manufacturers, where the edible articles 10 can be advantageously used in connection with a wide variety of existing candy manufacturing processes, yet without necessitating any equipment upgrades or modifications that would complicate the process or render them cost-prohibitive.

For example, in a preferred embodiment of the present invention, a plurality of edible articles 10, each formed as described above, can be placed within the hopper (not shown) of a standard candy depositor (not shown), where they are coated by liquid/molten candy (i.e., a candy mass having a temperature of about 280° F.). The specific molten candy selected may vary; however, it is preferred that the molten candy be inexpensive, substantially transparent, and should have a relatively quick cooling time. A currently preferred molten candy is a mixture of boiled sugar and corn syrup.

By virtue of having thicknesses that fall within the ranges listed above, the protective substrates 12, 14 (and, in turn, the entire edible article 10) generally will maintain their structural integrity during this coating process, even when exposed to the high temperature molten candy.

Once the candy mass/mix is cooled, it will contain the plurality of edible articles 10, which are generally scattered throughout the mix/mass. The candy mass can be cut (as is generally known in the art) and processed (e.g., via molding equipment) into desired sizes and shapes to form larger edible articles (not shown) that contain the edible articles 10, each of which produces holographic and/or lenticular images and/or effects by virtue of the embedded holographic and/or lenticular patterns or gratings.

This embodiment is advantageous because it enables the optical elements 16, which are contained within the edible article 10 and the surrounding candy, to last longer while the surrounding candy and substrates 12, 14 are being consumed—that is, the optical elements will remain optically active, and thus, will continue to produce visually interesting optical images and effects, until both the surrounding candy and the protective substrates 12, 14 are consumed.

In an alternate embodiment of the present invention, at least one substrate 12 and/or 14 can be formed from a mold that is not relief mold—that is, from a so-called “blank mold” that does not include a diffractive, holographic or lenticular relief pattern of grating. In such an embodiment, the substrates 12, 14 are formed as described above, i.e., by introducing film forming material into the relief mold and the blank mold, and then drying the film forming material or allowing it to set.

In one version of this alternate embodiment, the substrates 12 in communication with the blank mold 23 is heat stamped (i.e., embossed) on one of its sides 18 with a heated (i.e., to above about 200° F.) transfer plate 24 that includes a holographic or lenticular grating 16. This embodiment is depicted in FIG. 4a (prior to heat stamping) and FIG. 4b (during the heat stamping process).

Following the heat stamping process, the substrates are demolded, and the side/surface 18 of the substrate 12 that contacted the heat stamping plate/device 24 will include a holographic or lenticular grating or pattern 16 similar to the pattern or grating that was transferred to the substrates 12, 14 via a relief pattern or grating from a relief mold.

In another version of this embodiment, a printed pattern (not shown) may be introduced onto the substrate 12 in communication with the blank mold. Preferably, but not necessarily, this printed pattern is transferred to the substrate 12 prior to the substrate being demolded (i.e., while the substrate remains in communication with the blank mold), in order to provide a backing to the substrate during the printing process.

The blank mold, with substrate 12 or 14 in communication therewith, is fed into an ink-jet printer or other suitable device (e.g., a silk-screener or a flexo-printer), wherein edible ink is applied onto, and adsorbed by one side/surface of the substrate. The edible ink may form predetermined arrangements of colors, letters, numbers, symbols, optical interference patterns, designs, or a combination thereof. The ink is preferably opaque to contrast usually with surrounding areas not imprinted. When printed as closely and regularly spaced opaque lines, an interference-producing pattern is obtained.

Preferably, substrates that are to be imprinted with such a printed pattern are formed from HPMC, or a modified starch or gel material, in order to increase the likelihood that the ink from the printer will be entirely and evenly adsorbed by the substrates without (or with minimal) bleeding, and to ultimately increase the visibility of the high resolution (e.g., in the range of about 250 dpi to 1440 dpi) printed images and effects that will be produced by the printed patterns.

Use of this imprinting technique is advantageous because the resulting printed patterns can be highly detailed, and can produce very unique, tailored images and/or effects when viewed.

In yet another version of this embodiment, an optical element may be ablated onto a blank mold substrate 12 or 14 either prior to or following demolding. In such an embodiment, ablation removes a predetermined amount of the substrate material to define a high resolution relief pattern or grating. The term “ablation” refers to surface evaporation caused by the intense local heating and photodissolution that results from exposure of the substrate surface to an high energy/heat source, e.g., a phase mask, ion beam, E beam lithograph, or, preferably, a laser.

FIG. 5 depicts an embodiment of the present invention in which a laser 100 is employed to produce optical relief patterns or gratings on the surface of a substrate. A high energy laser light source 100 (shown as two sources 110, but typically it is one source whose output beam is split) produces two beams 120, 120 of laser light that interfere in a region 130 to produce a desired interference pattern 16 of light intensity maxima and minima. A substrate 12 is positioned in the region 130 with one side facing the beams 120, 120.

Operation of the laser 100 causes lines of maximum light energy to create corresponding grooves (i.e., a microrelief) into the side of the substrate, and lines of minimum light intensity to produce corresponding ridges in the side of the substrate. A microrelief pattern or grating is thus formed directly by a pattern of light energy being burned into” the surface of one side of the substrate. Because the interference pattern occurs over a region, it automatically adjusts to variations of the substrate from a perfectly flat condition.

Exemplary lasers for practicing this embodiment of the present invention include neodymium-yag (i.e., yttrium aluminum garnet) lasers having a pulse width of 10 ns, a repetitive frequency of 10 Hz, and an irraditaion energy (before division of beams 120, 120) of 110 mJ/cm² and a frequency of 335 nm (wherein the frequency can range from about 150 nm to 700 nm depending on the substrate material), and KᵣF (krypton-fluoride) excimer lasers emitting 20 ns-duration pulses at 250 nm, and having a surface low etch threshold value of about 100 mJ/cm², and a high-damage threshold value of about 3000 mJ/cm².

It will be recognized by those skilled in the art that other types of lasers and/or different frequencies may be used in practicing the present invention, depending on the shape, size and/or composition of the substrate surface to be ablated.

This ablation procedure is very advantageous, because it can produce relief gratings or patterns in fractions of a second. Moreover, the ablation procedure, in addition to being incorporated in a process whereby an edible article is formed, can also be used to ablate an already-formed edible article in order to define a relief pattern or grating on the surface thereof.

Thus, substrates 12, 14 may be formed to include optical elements 16 via any of the relief mold (i.e., casting), heat stamping, imprinting, and laser ablation techniques described above. Both substrates 12, 14 may be formed via the same, or different techniques in accordance with the present invention. This provides important design, manufacturing and cost flexibility.

In an exemplary embodiment of the present invention where the substrates 12, 14 are formed via differing techniques, an edible article for promotional purposes can be created by sealing together a substrate 12 that includes as its optical element 16 a printed pattern of a company's logo, and a substrate 14 that includes as its optical element 16 a holographic relief grating. The resulting edible article, when viewed, will include the image of the hologram, e.g. a “rainbow” of colors, superimposed on the company logo, or vice versa.

Referring again specifically to the relief molding technique, it may be modified to allow for production of several partial edible articles (in particular, candies), each of which includes/incorporates at least one optical element, and which, collectively, can be united to form/define a larger, single edible article.

In such an embodiment, a film forming solution is introduced into a relief mold as described above. However, the relief mold is sized not only to accommodate the film forming material, but also a quantity of candy, which is introduced in a liquified/molten state atop the film forming material after the film forming material has dried/set to form a substrate, but before the substrate has been demolded.

Once the liquified/molten candy has dried/set, it is removed from the mold. As it was drying/setting, the molten candy will have become attached to the side/surface of the substrate atop which it had been introduced. Thus, upon demolding the substrate and solidified candy, not only will one side of the substrate have been imprinted with the relief pattern/grating from the relief mold, but the other side will be attached to the dried/set candy. This forms a partial edible article 10a. This process can be repeated (simultaneously in a plurality of molds, or over a predetermined time frame in the same molds or several different molds) in order to produce a plurality or multiplicity of partial edible articles 10a, 10b, 10c, etc.

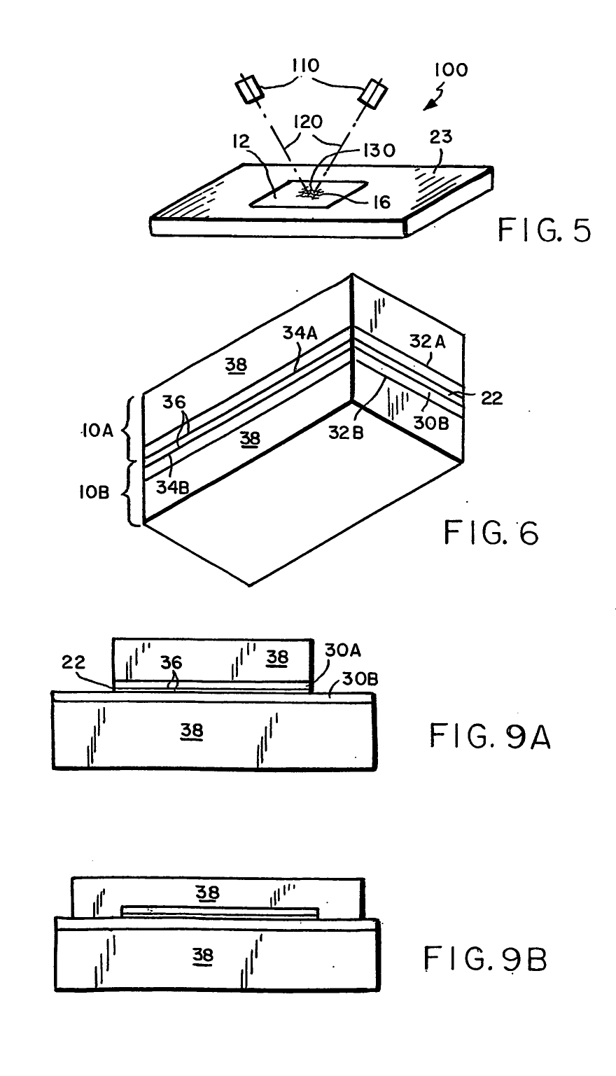

In an exemplary embodiment (see FIG. 6) of the present invention, two partial edible articles 10a, 10b can be placed into communication with (i.e., attached to) each other such that cooled candy 38 borders one side 32a, 32b of each substrate 30a, 30b, and such that the sides 34a, 34b of the substrates 30a, 30b that include relief gratings 36 are facing each other to define an optical gap (not shown) between the relief gratings present on the first partial edible article 10a, and those present on the second partial edible article 10b.

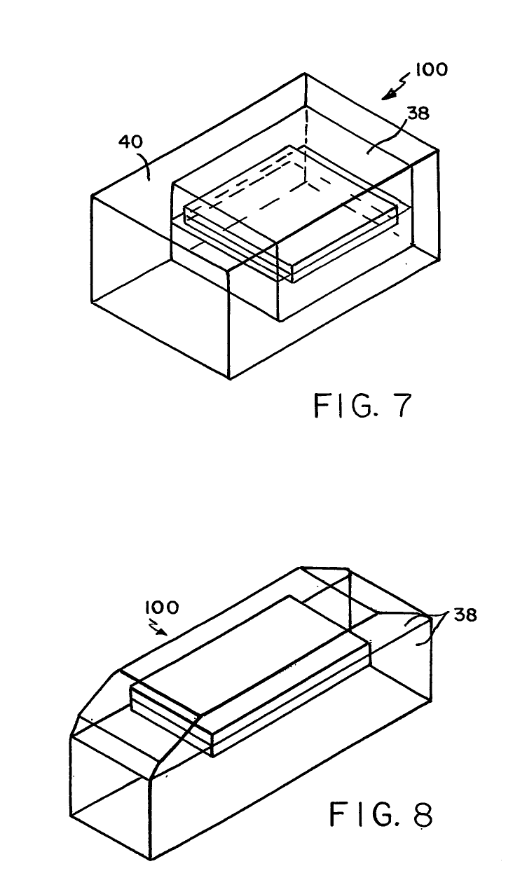

The partial edible articles 10a, 10b then may be united to form a larger, single edible article 100 in one of several ways. For example, they may be placed into an additional mold (not shown), and then covered by a layer of molten candy 40 to entirely or partially enclose the partial edible articles 10a, 10b to form a larger edible article 100, as shown in FIG. 7.

Alternatively, molten candy can be introduced in targeted manners and/or to targeted areas of the edible article portions, e.g., to border areas and/or edges to effect sealing of these areas.

In still another embodiment, one or both edible articles 10a, 10b can be heat sealed or heat bonded, wherein the heat causes the cooled candy 38 to reenter the molten state, such that the candy melts around the edges/borders of the substrates 30a, 30b, which, therefore, become joined to form a united, larger edible article 100.

For example, the partial edible articles 10a may be crimped by a heated crimping apparatus (not shown) to cause candy 38 to melt around the borders and/or edges of the substrates 30a, 30b. This not only seals the partial edible articles 10a, 10b together to form a united edible article 100, but also allows for the united edible article to have a visually interesting shape. For example, a crimped edible article 100 is shown in FIG. 8 as having a trapezoidal shape.

As another example, the partial edible articles 10a, 10b may be formed to have differing widths, as shown in FIG. 9a, where the first partial edible article 10a has a smaller width than the second partial edible article 10b. This can be accomplished, e.g., by forming the partial edible articles 10a, 10b in molds with differing widths.

In order to unite the partial edible articles 10a, 10b in accordance with such an embodiment, they are placed with their optical patterns or gratings 36 facing each other as described above. Then, heat is applied (e.g., via heat bonding or heat sealing) to the first partial edible article 10a. This causes the candy layer 38 atop the first edible article 10a to become molten, wherein the molten candy 38 begins to flow, thus causing the width of the candy to expand as shown in FIG. 9b, wherein the width of the first edible article has expanded, and, in the process, has sealed the first edible article 10a to the second edible article 10b to form a larger, united edible article 100.

Although FIGS. 6-8, 9a and 9b depict embodiments of the present invention where only two partial edible articles 10a, 10b are joined to form a larger, united edible article 100, it is possible to form a united edible article 100 from more than two partial edible articles in any of the manners described above (e.g., coating with molten candy, heat sealing, crimping).

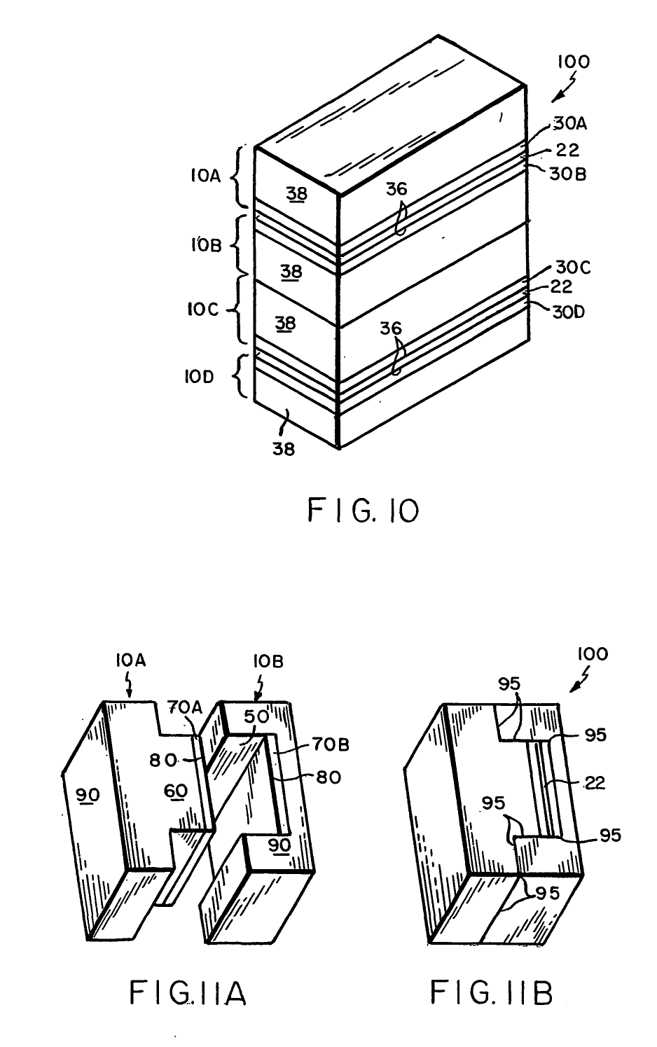

For example, partial edible articles 10a, 10b may be stacked (as shown in FIG. 6), which, in turn, may be stacked atop other partial edible articles 10c, 10d (as shown in FIG. 10). Once stacked as desired, the partial edible articles 10a, 10b, 10c, 10d are united to form a single, larger edible article 100 via any of the aforementioned techniques.

Although FIG. 10 depicts four stacked partial edible articles 10a, 10b, 10c, 10d it is understood that an edible article 100 of this type can be formed from more (or fewer) than four partial edible articles, if desired, and/or that either an even or a non-even number of partial edible articles may be united to form edible article 100.

Forming a edible article 100 from a plurality of partial edible articles 10a, 10b, 10c, 10d is advantageous, because complex, multi-layered images and/or effects can be created based on the number of optical elements 16 included in the partial edible articles 10a, 1b, 10c, 10d the type of optical elements selected, and the positions the optical elements occupy in each partial edible article.

By way of non-limiting example, images and/or effects produced by the optical elements 16 may be initially hidden (e.g., shielded due to coloring of candy 38), but can emerge as the edible article 100 is being consumed. Also, based on the positioning of the optical elements 16 within the edible article 100, some or all of the optical elements can produce distorted or out of focus images, which, during consumption of the edible article, eventually become focused. Additionally, the optical elements 16 may be positioned to interact with each other by forming interference patterns, which themselves may be initially evident or hidden, and/or by producing images/effects that appear three-dimensional.

The enclosed optical elements 16 can also be selected and positioned to produce pre-distorted anamorphic images that, when distorted, look to be in proper perspective. For example, a three-dimensional image of a football may appear as a flat oval, which is then distorted produce a curved image that resembles an actual football.

In a currently preferred embodiment of the present invention, a multi-layered edible article 100 includes layers of different flavors and/or colors, and includes embedded optical elements that are selectively revealed or exposed during consumption of the various partial edible articles 10a, 10b, 10c, 10d that comprise the edible article 100.

By way of non-limiting example, a dissolve illusion can be created, wherein a partial edible article 10a of the multi-layered edible article 100 has an apple flavor, and, contains a holographic grating that, when viewed, produces an image of an apple. Once that partial edible article 10a of the edible article 100 is consumed, and the next partial edible article 10b is encountered, the flavor shifts to cherry, and a holographic image (previously not discernable to the individual eating the edible article) of a cherry begins to emerge due to the presence of a holographic cherry grating within the second partial edible article 10b. Similarly, partial edible article 10c could produce a lemon flavor and could contain an optical element that produces an image of a lemon, and partial edible article 10d, when consumed, could taste like an orange, and could contain an optical element that produces an image of an orange.

In accordance with another embodiment of the present invention, partial edible articles 10a, 10b also may be manufactured to have shapes (see FIGS. 11a and 11b) that allow them to interlock in order to form a larger, single edible article 100.

By way of non-limiting example, one partial edible article 10b may emerge from a mold that includes a positive surface feature, such that the resulting partial edible article 10b will have a negative surface feature 50 upon removal from the mold. Another partial edible 10a article may emerge from a mold that includes a negative surface feature that substantially resembles (e.g., in dimensions and/or shape) the negative surface feature of the first partial edible article 10b. This, in turn, will cause the resulting second partial edible article 10a to have a positive surface feature 60 upon removal from the mold. As before, each partial edible article 10a or 10b, will include a substrate 70a, 70b, which, on one of its sides, will be include at least one holographic, lenticular, or printed pattern or grating 80, and, on its other side, will be in communication with a quantity of candy 90.

The partial edible articles 10a, 10b can be interlocked (see FIG. 11b), after which they can be heat sealed, wherein the elevated temperature will cause the candy 90 present in the partial edible article 10a, 10b to form a securing ring/layer between the partial edible articles 10a, 10b at one or more edges and/or border areas 95, thus providing a larger, united edible article 100.

It is understood that this securing ring/layer can be formed without heat sealing the partial edible articles 10a, 10b. For example, if the candy 90 contains certain ingredients (e.g., corn syrup), the partial edible articles 10a, 10b, once interlocked as shown in FIG. 11b, will experience so-called “cold flow,” whereby the candy 90 from the partial edible articles 10a, 10b will become joined, e.g. at the border areas 95, to form an edible article 100.

The actual time that must elapse in order for the partial edible articles 10a, 10b, to be joined to form a united edible article 100 via cold flow may range from hours to weeks, depending on many factors, e.g., the composition of the candy 90 and/or the humidity of the environment in which the partial edible articles 10a, 10b are placed during the cold flow period.

The interlocking partial edible articles 10a, 10b of FIGS. 11a and 11b are merely illustrative examples. It is understood that more than two partial edible articles 10a, 10b may be interlocked together in different predetermined arrangements and/or positions, and that the interlocking shapes may be different than those depicted in these Figures.

This particular embodiment is advantageous because not only can it result in visually interesting and unique edible articles, but it does not necessitate the step of sealing the partial edible articles 10a, 10b via a molten layer of candy, thus reducing manufacturing time and cost.

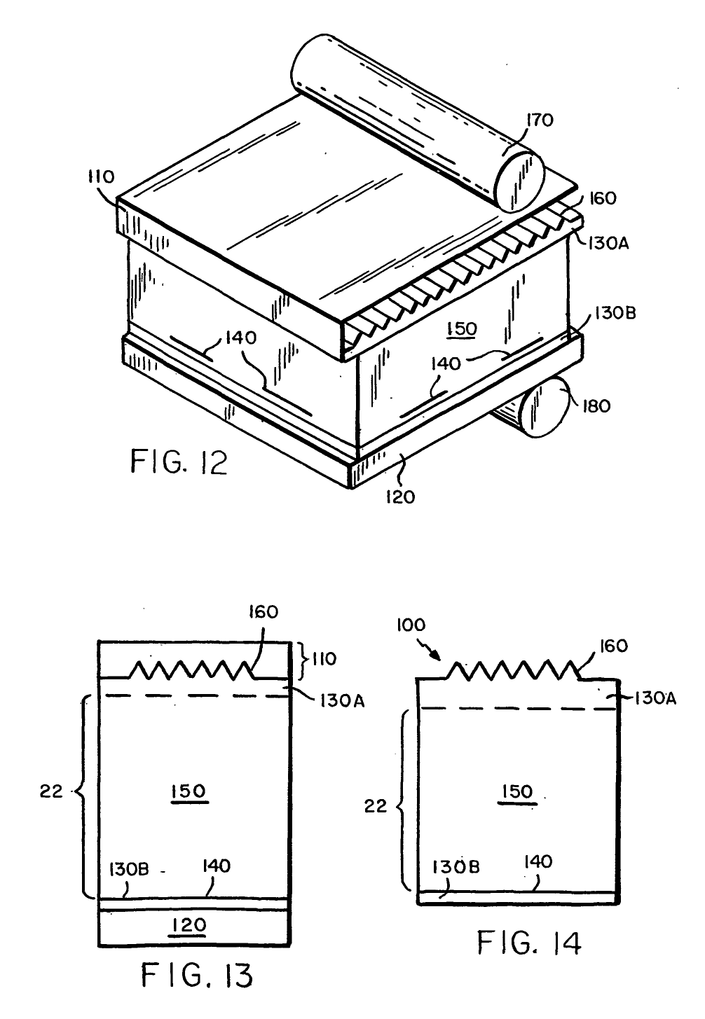

Referring now to FIGS. 12 and 13, although lenticular optical patterns or gratings may be formed as discussed above, these figures depict a preferred arrangement/method for forming edible articles 100 that include a plurality of lenticular patterns and/or gratings.

In accordance with such a method, film forming solution is introduced (as described above) to a relief mold 110 that includes one or more lenticular gratings, and a second mold 120, which is either a relief mold or, preferably, a blank mold. After the film forming solutions in each mold 110, 120 have dried/set to form substrates 130a, 130b, but prior to the substrates being demolded, the blank mold 120 is imprinted (e.g., introduced into an ink jet printer) with a printed pattern 140 as described above. Then, molten candy 150 (e.g., a boiled sugar/corn syrup mixture) is introduced atop the exposed side of the either or both substrates 130a, 130b (i.e., the side of the substrates that is not in communication with the mold) while both substrates remain with their respective molds.

While the molten candy remains in a molten state (i.e., while it is malleable), the substrates 130a, 130b are atop placed each other with the layer of candy 150 being located (i.e., sandwiched) in between the substrates. The resulting structure is shown FIG. 13 as a relief mold 110, the lenticular relief grating on the mold 160, a first substrate 130a, molten candy 150, a printed pattern 140, a second substrate 130b, and a second mold 120.

Still while the molten candy is at least partially molten (i.e., is malleable), this structure is preferably fed between sizing rollers 170, 180 (see FIG. 12) in order to tailor the thickness of the candy 150, and, in turn, to control the width of the optical gap (not shown) between the lenticular grating 160 and the printed pattern 140. The optical gap width should be approximately equal to the predetermined focal distance that is required between the lenticular grating 160 and the printed pattern 140, in order for these optical elements to combine (e.g., interlace) to produce a desired visual effect and/or image when viewed.

After the molten candy cools, the molds 110, 120 are removed to produce an edible article 100 (see FIG. 14), which can represent a final product or can be further incorporated into a larger edible article through any of the techniques described above.

The substrate 130 is depicted in FIG. 14 as a dashed line because its presence in the edible article 100 is not necessarily required. For example, in a related embodiment of the present invention, molten candy 150 can be poured directly atop a relief mold 110, thus eliminating the need for the first substrate 130a located between the relief mold and the molten candy. The process for forming the edible article 100 is otherwise identical to that described above and depicted in FIGS. 12 and 13, except that the resulting edible article will not include the first substrate 130a, and the lenticular pattern or grating 160 is transferred from the relief mold directly to the molten candy 150.

This related embodiment is advantageous because of the time and materials savings obtained by eliminating the first substrate 130a. Moreover, the lenticular grating 160, because of its size and geometry, will not be rendered optically ineffective despite being directly contacted by the molten candy.

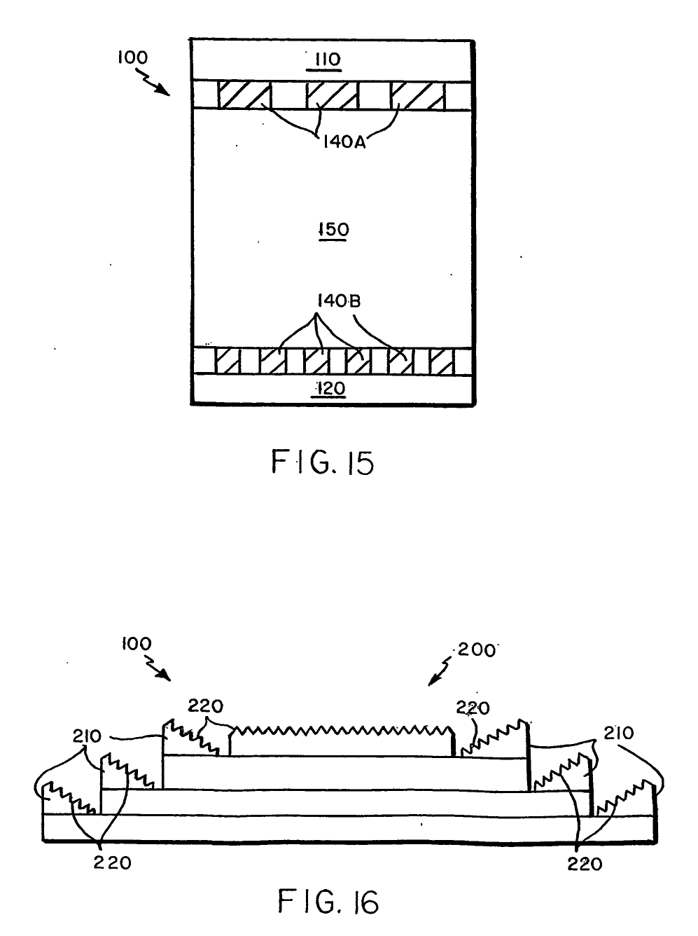

In yet another related embodiment depicted in FIG. 15, both molds 110, 120 can be blank molds, which are imprinted with differing printed patterns 140a, 140b. Preferred printed patterns 140a, 140b include, but are not limited to, line arrangements that, when ultimately viewed with a predetermined focal distance (set by the rollers) therebetween, create an interference or moiré pattern. Other preferred patterns include vertical lines and alternating images that, when viewed, generate differing images and/or effects depending on the angle of viewing.

In addition to the embodiments described and depicted above, several alternative embodiments of the present invention are described below.

FIG. 16 depicts yet another embodiment of the present invention, wherein a shaped edible article 200 can integrate stepped lenticular or fresnel shapes 210 to help direct light from a transferred diffraction grating 220 on a curved surface, in order to reduce surface distortion.

In accordance with still another exemplary embodiment of the present invention, a printed pattern is introduced onto a substrate, which is then attached to molten candy to form an edible article. For example, a quantity of film forming solution may be introduced into a blank mold as described above. Once the solution dries/sets to form a substrate, the mold (with substrate in communication therewith) is placed into a device (e.g., an ink-jet printer), which introduces ink onto a top, exposed surface of the substrate (i.e., the surface of the substrate that is not in communication with the blank mold). The ink is adsorbed by the top surface of the substrate to form a predetermined printed pattern, e.g., an arrangement of lines.

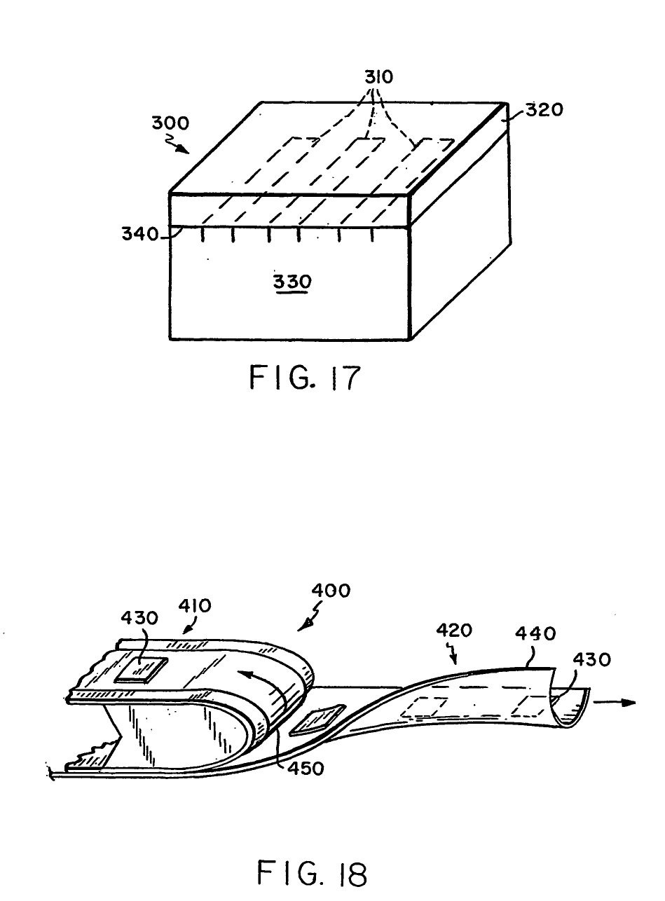

The substrate is then brought into contact with a quantity of at least partially molten candy. Preferably, this is accomplished by placing the substrate atop a quantity of molten candy such that the surface of the substrate that has been imprinted with the printed pattern is in communication with a surface of the molten candy. Due to the temperature (e.g., at least about 280° F.) of the molten candy, the substrate will be become attached to the molten candy as the molten candy cools. Either before or, preferably, after the candy has cooled, the substrate is demolded (e.g., the mold is peeled away) to reveal an edible article 300, which, as depicted in FIG. 17, includes candy 330, and a substrate 320 with a printed pattern 310 on a surface 340 of the substrate.

Also, although not shown, an additional coating of candy can be applied onto the edible article 300, e.g., in order to introduce an additional flavor and/or to enlarge the edible article.

FIG. 18 depicts still yet another embodiment of the present invention, wherein edible articles may be continuously manufactured with high throughput. In accordance with this embodiment, candy is manufactured without the use of molds. Instead, a conveyor mechanism 400 is provided that includes two belts 410, 420.

A film forming material 430 is applied or otherwise introduced onto the first belt 410 that includes a relief pattern or grating. Generally, the belt is heated (e.g., to above 200° F.), such that the film forming material forms a substrate 430, and such that the relief pattern or grating is transferred to the substrate.

The second belt 420 of the conveyor includes a quantity of candy (e.g., ribbon candy) 440 that is at least partially molten and at least partially malleable.

The belts 410, 420 converge at a predetermined area 450, at which the substrate 430 contacts the molten candy 440, which, due to being somewhat “sticky” due to being in an at least partially molten state, causes the substrate to be removed from the first belt 410, and to adhere to the molten candy.

As the candy 440 with adhering substrate 430 proceeds on the belt 420, the candy is folded atop itself, thus enclosing the substrate to form a folded edible article 500. As the folded edible article 500 leaves the second belt mechanism 420, it can be cut into individual edible articles of predetermined size and shape to form, e.g., ribbon or rope candies.

The foregoing description of the invention is merely illustrative thereof, and it is understood that variations and modifications can be effected without departing from the scope or spirit of the invention as set forth in the following claims. All documents mentioned herein are incorporated by reference herein in their entirety.

What is claimed is:

1. An edible article, comprising:
an outer periphery;
an inner area, at least a portion of which defines an optical gap; and
at least one edible pattern in communication with the edible article, the pattern being carried on an edible image retaining element and being capable of producing at least one image or effect.

2. The edible article of claim 1, wherein each of the at least one pattern is selected from the group consisting of diffraction patterns, lenticular patterns, printed patterns, and combinations thereof.

3. The edible article of claim 1, wherein the pattern is transferred by a method of casting.

4. The edible article of claim 1, wherein the pattern is transferred by a method of embossing.

5. The edible article of claim 1, wherein the pattern is ablated by a method of exposure to a high energy source.

6. The edible article of claim 1, wherein the pattern is transferred by a method of printing.

7. An edible article of claim 5, wherein the outer periphery is a surface of a high resolution diffraction relief and the inner area is selected from the group of carbohydrates, amino acid polymers, fats and combinations thereof.

8. The edible article of claim 1, wherein the edible article is comprised of first and second edible image retaining elements that are bonded together to define both the outer periphery of the edible article and the inner area within the edible article.

9. The edible article of claim 8 wherein the first and second image retaining elements are substrates and are bonded together by a heat sealing technique.

10. The edible article of claim 1, wherein the outer periphery of the edible article is least partially coated with a hard-boiled candy.

11. The edible article of claim 1, wherein at least one of the at least one pattern is hidden from view prior to at least partial consumption of the edible article.

12. The edible article of claim 9, wherein the first and second image retaining elements are at least partially coated with a candy mass prior to being sealed together.

13. The edible article of claim 12, wherein the first and second image retaining elements are bonded together by use of a molten candy sealing ring.

14. A method for producing an edible article, comprising the steps of:
introducing an edible film forming material into at least two holding areas, wherein at least one holding area is designed to allow for transfer of at least one pattern to the film forming material, and wherein the pattern is selected from the group consisting of a diffraction pattern, a lenticular pattern, a printed patterns, and combinations thereof;
allowing the film forming material to set in each holding area to form a substrate in each holding area;
removing the substrates from each holding area, each substrate having a first surface and a second surface, wherein the pattern has been transferred to one of the first and second surface of at least one of the substrates; and
causing the first and second surfaces of the substrates to be connected such that an optical gap is defined between the first and second surfaces of each substrate to which the pattern has been transferred.

15. The method of claim 14, wherein the first and second surfaces of the substrate are caused to be connected via heat sealing.

16. The method of claim 14, further comprising the step of:
introducing the connected substrates into a candy mass.

17. A method for producing an edible article, comprising the steps of:
providing first and second substrates, each having first and second surfaces;
transferring a diffraction relief grating onto at least one of the first and second surfaces of at least one of the plurality of substrates; and
causing the first substrate to be connected to the second substrate such that an optical gap is formed between the first and second substrates, and such that each surface of the each substrate that includes a diffraction relief grating is facing toward the other surface of the substrate.

18. The method of claim 17, further comprising the step of:
bonding at least one of the first and second substrates to a layer of hard boiled candy.

19. A method of preparing an edible article having a high resolution diffraction relief which confers a holographic image on said product comprising the steps of:
providing a high energy source; and
exposing an edible article to a directed energy emanating from the high energy source such that a portion of the edible article is ablated to form a high resolution relief grating or pattern on the edible article.

20. The method of claim 17, wherein the relief grating or pattern is obtained either through a phase mask or through interference between two beams.

21. The method of claim 17, wherein the high energy source is a laser.

22. The method of claim 21, wherein the laser is a neodymium-yag laser with a frequency setting based on the energy absorption profile of the edible article.

23. A method for producing an edible article, comprising the steps of:
introducing a film forming material into at least two holding areas, wherein at least one holding area is designed to allow for the transfer of at least one pattern to the film forming material, and wherein the pattern is selected from the group consisting of a diffraction pattern, a lenticular pattern, a printed patterns, and combinations thereof;
allowing the mixture to set in each holding area such that a substrate is formed in each holding area, each substrate having first and second surfaces;
coating at least one of the substrates in the holding areas with a layer of hard boiled candy;
removing at least first and second substrates from their respective holding areas, at least one of the first and second substrates having a pattern on one of their first and second surfaces; and
causing the first and second substrates to be connected such that one of the first and second surfaces of the each substrate is facing one of the first and second surfaces of the other substrate, and such that an optical gap is defined between the facing surfaces of the first and second substrates.

24. The method of claim 23, wherein the first substrate is caused to be connected to the second substrate by bonding candy onto at least one of the first and second substrates.

25. The method of claim 23, further comprising the steps of:
shaping the articles into interlocking shapes; and
bonding the interlocking shapes together by a technique selected from the group consisting of heat flow, cold flow, and a combination thereof.

26. A method for producing an edible article, comprising the steps of:
introducing a first film forming material into a first holding area that includes a pattern with which the film forming material is in communication;
introducing a second film forming material into a second holding area;
allowing the mixtures to set in the first and second holding areas such that a first substrate is formed in the first holding area, and a second substrate is formed in the second holding area, the first substrate having a first surface in communication with the first holding area, and a second surface, and the second substrate having a first surface in communication with the second holding area, and a second surface;
bonding the second surface of the first substrate and the second surface of the second substrate together with molten candy such that the second surface of the first substrate is separated from the second surface of the second substrate by a predetermined distance;
adjusting the predetermined distance;
allowing the molten candy to substantially cool; and
removing the first and second holding areas.

27. The method of claim 26, wherein the first film forming material is a hard boiled confection, wherein the pattern is a relief pattern, and wherein, prior to bonding the first and second substrates, the second surface of the second substrate is imprinted with a printed pattern.

28. The method of claim 27, wherein the relief pattern is at least one lenticular pattern.

29. The method of claim 26, wherein the at least one sizing roller is used to adjust the predetermined distance between the second surface of the first substrate and the second surface of the second substrate.

30. The method of claim 26, wherein the second surface of the first substrate and the second surface of the second substrate both include printed pattern, which can be superimposed when viewed in a predetermined manner.

31. A method of forming an edible article, comprising the steps of:
providing a mold;
introducing film forming solution onto the mold;
allowing the film forming solution to form a substrate having a first, bottom surface, and an exposed, top surface;
introducing a printed pattern onto the exposed, top surface of the substrate;
placing the exposed, top surface of the substrate into communication with a surface of a quantity of molten candy;
allowing the substrate to become attached to the surface of the quantity of molten candy, such that the printed pattern is in contact with the surface of the molten candy; and
removing the mold, such that the substrate remains attached to the molten candy.

32. The method of claim 31, wherein the mold is a blank mold.

33. The method of claim 31, wherein the printed pattern is introduced onto the exposed second surface via a printer device.

34. The method of claim 33, wherein the printer device is a ink jet printer.

35. The method of claim 31, wherein the molten candy is allowed to cool prior to the step of removing the mold.

36. A method of producing an optical pattern on an edible article via a laser, comprising the steps of:
providing an edible article; and
causing the laser to emit first and second beams of light that interfere to produce a desired interference pattern on a surface of the edible article, and wherein the interference pattern produces an optical pattern on the surface of the edible article.

37. The method of claim 36, wherein the interference pattern is comprised of light intensity maxima and minima.

38. The method of claim 36, wherein the edible article is a candy.

39. The method of claim 36, wherein the optical pattern is a microrelief.

40. The method of claim 37, wherein the optical pattern is comprised of a plurality of grooves produced by lines of minimum light intensity from the interference pattern, and a plurality of ridges produced by lines of maximum light intensity from the interference pattern.

41. A method of producing an edible article, comprising the steps of:
providing a blank mold;
introducing film solution material onto the blank mold;
allowing the film forming solution to form a first substrate having a first, bottom surface, and an exposed, top surface; and
producing an optical pattern on the exposed, top surface of the first substrate;
combining the first substrate with at least one other substrate to form an edible article.

42. The method of claim 41, wherein the optical pattern is produced via a laser.

43. The method of claim 42, wherein the step of producing an optical pattern on the exposed, top surface of the edible article is achieved by causing the laser to emit first and second beams of light that interfere to produce a desired interference pattern on the exposed, top surface of the substrate.

44. The method of claim 43, wherein the interference pattern is comprised of light intensity maxima and minima.

45. The method of claim 41, wherein the optical pattern is a microrelief.

46. The method of claim 41, wherein the optical pattern is comprised of a plurality of grooves produced by lines of minimum light intensity from the interference pattern, and a plurality of ridges produced by lines of maximum light intensity from the interference pattern.

47. The edible article of claim 1, wherein the outer periphery is at least partially curved, and wherein the edible article incorporates at least one fresnel shape.
